(19) United States
(12) Patent Application Publication
(10) Pub. No.: US 2017/0225499 A1
(43) Pub. Date: Aug. 10, 2017

(54) DETERMINING AN ALIGNMENT CHARACTERISTIC

(71) Applicants: Xavier QUINTERO RUIZ, Sant Cugat del Valles (ES); David GASTON, Sant Cugat del Valles (ES); HEWLETT-PACKARD DEVELOPMENT COMPANY, L.P., Houston, TX (US)

(72) Inventors: Xavier Quintero Ruiz, Sant Cugat del Valles (ES); David Gaston Llado, Barcelona (ES)

(73) Assignee: HEWLETT-PACKARD DEVELOPMENT COMPANY, L.P., Houston, TX (US)

(21) Appl. No.: 15/502,302

(22) PCT Filed: Aug. 25, 2014
(86) PCT No.: PCT/EP2014/067978

§ 371 Date: Feb. 7, 2017

(51) Int. Cl. B41J 29/393

(52) U.S. Cl. CPC B41J 29/393

(57) ABSTRACT

According to one example, there is provided a method of determining an alignment characteristic of a printhead die installed in a printer. The method comprises controlling the printer to print a predetermined pattern using the printhead die and determining, through analysis of the distance between features of the printed predetermined pattern, alignment characteristics of the printhead die.

### BACKGROUND

Scanning inkjet printers typically have a relatively small printhead compared to the width of media on which they are used to print on. Printheads are scanned across the width of the media, in one or multiple passes, to print a swath of an image. The media is then advanced a small distance to allow a subsequent swath to be printed. The time taken to generate printed output is therefore highly dependent on the time it takes the printheads to scan across the width of the media.

Page-wide array printers typically have a static wide array of inkjet nozzles configured to provide a print zone of a chosen width. Since the array of nozzles are not scanned across the width of the media, the media may be advanced in a continuous motion. This enables the printing speeds of page-wide array printers to be generally significantly higher than scanning inkjet printers.

### BRIEF DESCRIPTION

Examples will now be described, by way of non-limiting example only, with reference to the accompanying drawings, in which:

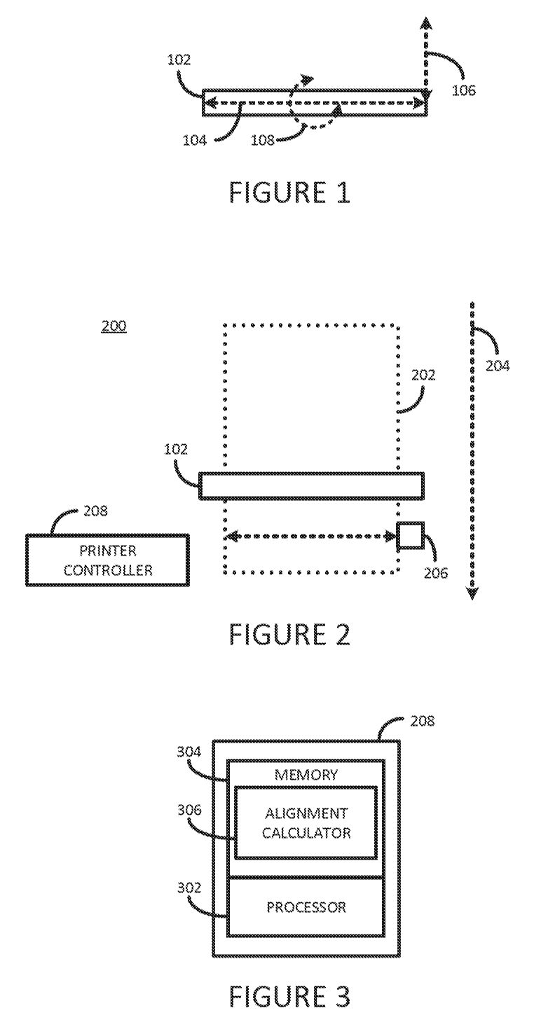

FIG. 1 is a simplified plan view of a print bar according to one example;

FIG. 2 is a simplified plan view of a printing system according to one example;

FIG. 3 is block, diagram of a printer controller according to one example;

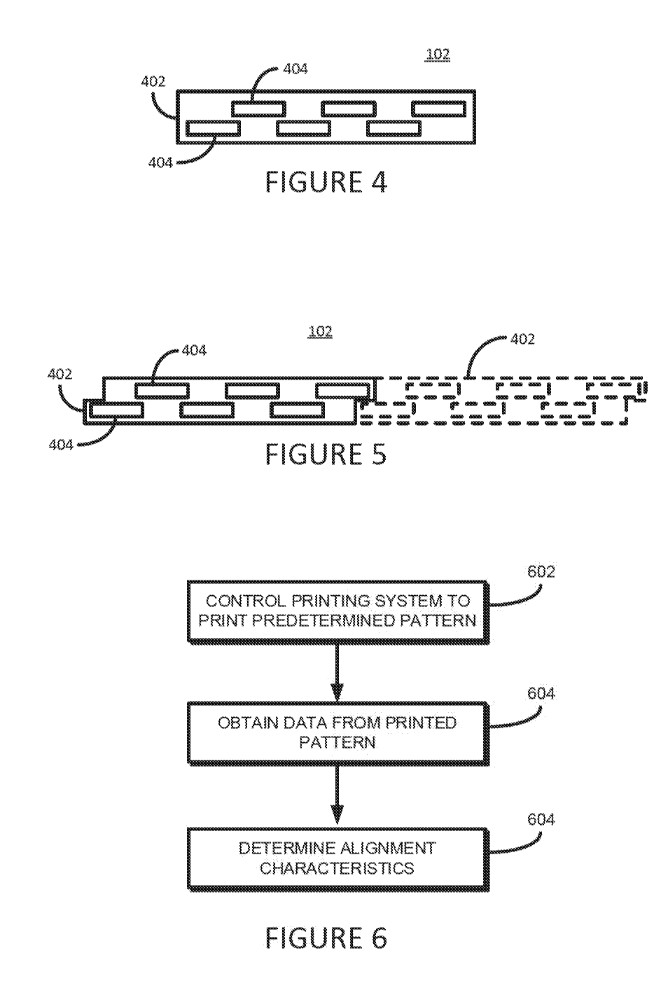

FIG. 4 is a simplified plan view of a printhead according to one example;

FIG. 5 is a simplified plan view of a print bar according to one example;

FIG. 6 is flow diagram outlining an example method of operating a printing system according to one example;

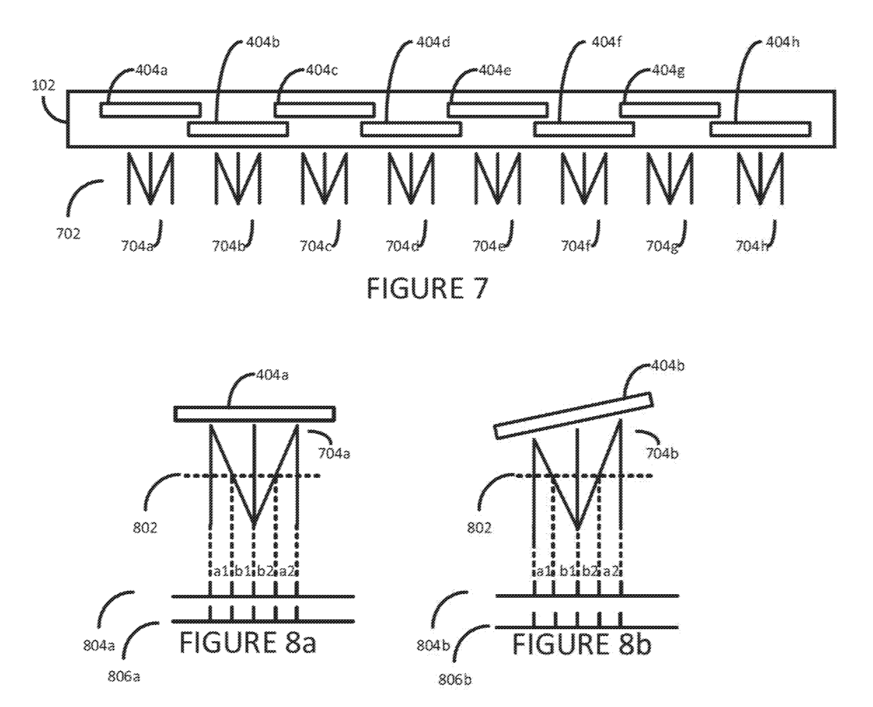

FIG. 7 is an illustration of a pattern printed by dies of a print bar according to one example;

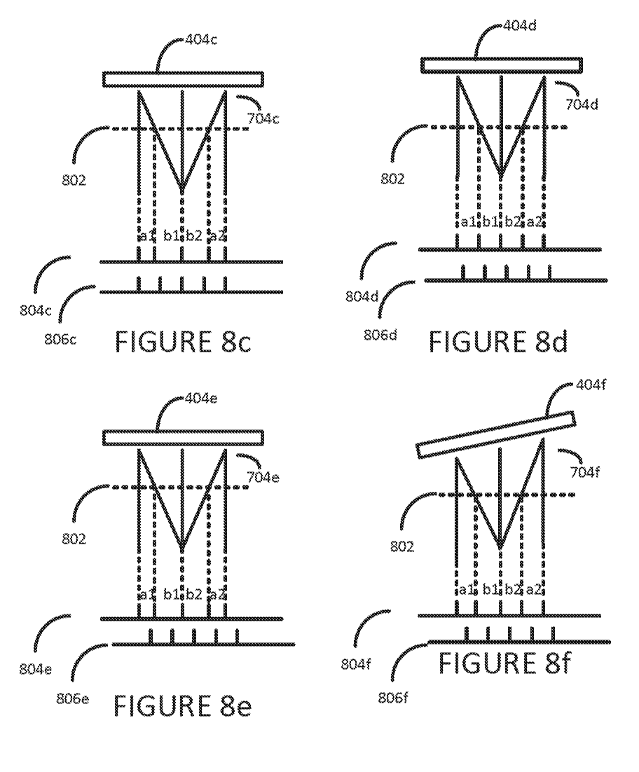

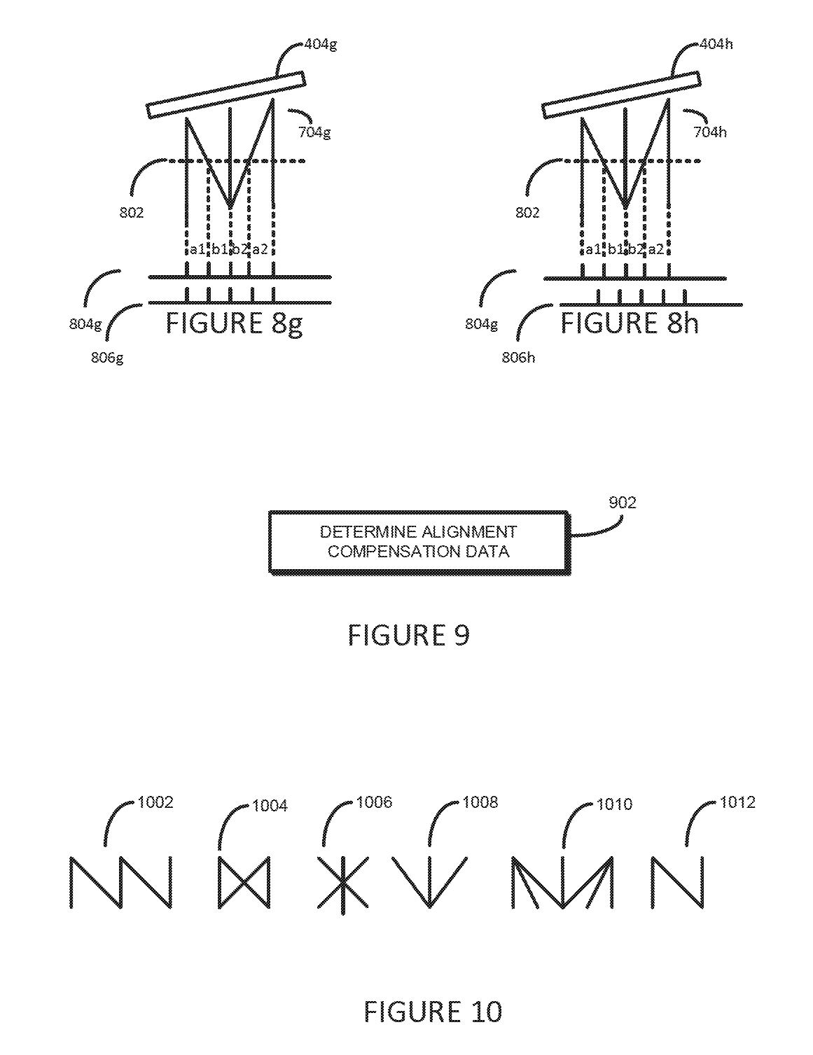

FIGS. 8a and 8h are illustrations of printed patterns according to one example;

FIG. 9 is flow diagram outlining an example method of operating a printing system according to one example; and

FIG. 10 is an illustration showing some additional patterns according to various examples.

### DETAILED DESCRIPTION

Some page-wide array printers have a single printhead that comprises multiple printhead dies. Each printhead die comprises a group of inkjet nozzles. Some page-wide array printers have multiple printheads that each comprise one or multiple dies. The printhead, or collection of printheads, define a print zone. Page-wide array office printers may, for example, have a print zone in the region of about 30 cm in length, whereas wide-format printers may have a print zone up to, or in excess of, 100 cm.

The printhead, or collection of printheads, in a page-wide printer is often referred to as a print bar.

In one example a page-wide array printer may have a print bar 1 m in length that may comprise multiple printhead dies, and may comprise more than 200000 inkjet nozzles.

To provide high quality prints, the different printhead dies in a print bar have to be accurately aligned with one another. Although printhead dies are generally aligned using accurate manufacturing processes, some misalignment of dies may be present in a printhead. Furthermore, where multiple printheads are used in a print bar, some misalignment may occur between dies of different printheads.

Although some mechanical misalignment is generally difficult to avoid the printer control systems generally allow for any such misalignment to be corrected for, for example by modifying the timing of nozzle firing signals.

However, before any misalignment compensation can be applied the extent of any misalignment has to be determined.

There exist three main types of die misalignment, as illustrated in FIG. 1 which shows a plan view of a print bar 102.

One type of die misalignment is print bar axis misalignment 104. Another type of die misalignment is cross-print bar axis misalignment 106, which is perpendicular to print bar axis misalignment 104. Another type of die misalignment is rotational misalignment 108, which is a rotational misalignment about a plane defined by the print bar axis 104 and the cross-print bar axis 106.

Examples described herein provide a printing system and a method of operating a printing system that enables the aforementioned types of die misalignment to be determined in a simple and efficient manner by printing and analyzing a predetermined test pattern.

Referring now to FIG. 2 there is shown a simplified plan view of a printing system 200 according to one example.

The printing system 200 comprises a page-wide array print bar 102 comprising one or multiple printhead dies. A media 202, when present in the printing system 200, may have content printed thereon by advancing the media 202 in a media advance axis 204 under the print bar 102.

The printing system 200 further comprises an imaging module 206, such as an optical scanner, that can obtain data representing a portion of printed content printed on the media 202. In one example the obtained data may be a digital data signal representing an electrical signal. In another example the obtained data may be in the form of image data.

In one example the imaging module 206 may scan back and forth along the print bar axis, for example if the imaging module 206 is narrower than the width of the media 202.

In one example the imaging module 206 may comprise a light source to direct light onto the media 202 and may comprise a light sensor that generates an electrical signal based on the amount of light reflected from the media 202. For example, portions of a media on which no pattern is printed may result in an electrical voltage at a first level (such as 0 V) being obtained, and portions of a media on which a portion of a printed pattern is printed may result in an electrical voltage at a second level (such as 5 V) being obtained. in other examples other types of electrical signal, such as an electrical current, may be obtained. In other examples other levels of electrical signal may be obtained. In some examples the light source may be changed, or selected, based on the color, or colors, of ink used to print the pattern 702. in one example the electrical signal may be converted into a digital data signal.

In another example the imaging module 206 may span the width of the media 202 and be static.

The operation of the printing system 200 is generally controlled by a printer controller 208, which is shown in greater detail in FIG. 3. The printer controller 208 comprises a processor 302, such as a microprocessor or microcontroller, coupled to a non-transitory computer readable memory 304, for example through a communications bus (not shown). The memory 304 stores printing system alignment calculator instructions 306 which are machine readable instructions that, when executed by the processor 302, cause the printer controller 208 to control the printing system 200 as described herein in various examples.

In one example, as illustrated in FIG. 4, the print bar 102 comprises a single printhead 402 that comprises an array of printhead dies 404. In one example the dies 404 may be arranged in an overlapping configuration to help reduce image quality problems compared to printhead dies which are linearly aligned.

In another example, as illustrated in FIG. 5, the print bar 102 comprises a plurality of printheads 402, with each printhead comprising one or multiple printhead dies. The configuration of the printheads 402 enable multiple printheads 402 to be assembled linearly, to provide a print bar 102 of a desired length.

Operation of the printing system 100, according to an example, will now be described with reference to the flow diagram of FIG. 6.

At block 602, the printer controller 208 controls the printing system 100 to print a predetermined pattern. In one example the printer controller 208 controls the printing system 100 to print the predetermined pattern in black ink. In other examples, however the printer controller 208 may control the printing system 100 to print the predetermined pattern using any one, or any combination, of the process inks available in the printing system 100.

An example of the predetermined pattern is shown as pattern 702 in FIG. 7. The pattern 702 comprises a set of one or multiple sub-patterns 704. In the example shown each sub-pattern 704a to 704h is arranged to be printed in its entirety by a single respective printhead die 404a to 404h. For example, sub-pattern 704a is printed in its entirety by printhead die 404a, sub-pattern 704b is printed in its entirety by printhead die 404b, and so on. In other examples, as described further below, the printer controller 208 controls the printing system 100 to print a different predetermined pattern.

In one example each sub-pattern 704 may be in the region of about 600 nozzles wide, and may be in the region of about 2 to 3 cm high. The width of each line may be in the region of about 40 nozzles wide. In other examples, however, each sub-pattern may be larger or smaller, or have thicker or thinner lines. As described below, different patterns 702 and sub-patterns 704 may be used in different examples. In one example, different patterns may be printed by different dies.

At block 604 the printer controller 208 controls the imaging module 206 to obtain data from at least a portion of the printed pattern 702. In one example, the printer controller 208 obtains data by controlling the imaging module 206 to obtain electrical signals based on the amount of light from a light source reflected from the media on which the pattern 702 has been printed.

In one example the printer controller 208 controls the imaging module 206 to scan at least a portion of the printed pattern 702.

In the examples described herein, the printer controller 208 controls the imaging module 206 to scan at least a portion of the printed pattern 702 that is mid-way between the top and the bottom of the first printed pattern 704a, as indicated by the dotted line 802 in FIG. 8a. For example, since the printer controller knows or may determine, the position of the pattern 704a on the media it may position the appropriate portion of the media under the imaging module 206 such that an appropriate portion of the pattern 704a is scanned.

In other examples the printer control 208 may control the imaging module 206 to scan at least a portion of the printed pattern 702 along a line that is not mid-way between the top and bottom of the first printed pattern 704a.

An example of the data signals obtained by the imaging module 206 are illustrated in FIGS. 8a to 8h as data signals 804a to 804h.

At block 604, the printer controller 208 analyzes the obtained data signals to determine alignment characteristics of different ones of the printhead dies 404a to 404g in the print bar 102. In one example the printer control 208 compares the obtained data signal with a reference, or expected, data signal. In one example the reference data signal may represent a reference electrical signal. The reference data signal may be generated, for example, based on the position along which the printed pattern 702 is scanned.

Referring to FIGS. 8a to 8h, it can be seen that the data signals 804a to 804h respectively correspond to portions of the printed patterns 704a 704h, along the line 802. Alignment characteristics of a printhead die may thus be determined based on the determined distances between different portions of the scanned printed pattern. For example, the distance between each of the peaks of the data signals 804a to 804h is denoted by the lengths a1, b1, b2, and a2. As can be seen in FIG. 8a, the sub-pattern 704a is designed such that, when the imaging member is scanned along the line 802 which is mid-way between the top and the bottom of the sub-pattern, the lengths of a1, b1, b2, and a2 are equal. If, however, the imaging member is scanned along a line which is not mid-way between the top and the bottom of the pattern the lengths of a1, b1, b2, and a2 will change accordingly.

As can be seen in FIG. 8a, the obtained signal 804a is perfectly aligned with the reference or expected data 806a. This indicates that the die 404a that printed the sub-pattern 704a is aligned in the print bar axis, in the cross-axis, and is not rotationally misaligned.

If however, the die which printed the sub-pattern 704 were misaligned, the data signal obtained from each scanned sub-pattern will differ from the reference data signal 806a as shown in FIGS. 8b to 8h.

As can be seen in FIG. 8b, the die 404b that printed the sub-pattern 704b is rotationally misaligned compared to the die 404a. This results in the lengths a1, b1, b2, and a2 not being equal. A positive or negative angle of misalignment can be determined from the relationship between a1 & a2 and between b1 & b2, For example, if a1<a2 and b1>b2, this indicates that the die that printed the pattern has a rotational misalignment in a counterclockwise direction, as shown in FIG. 8b. Similarly, if a1>a2 and b1<b2, this would indicate that the die that printed the pattern has a rotational misalignment in a clockwise direction

As illustrated in FIG. 8c, the die 404c that printed the sub-pattern 704c is misaligned in the cross print bar axis which results in the scan line 802 not being mid-way between the top and the bottom of the pattern 704c. This results in the lengths a1 and a2 being equal, and the lengths b1 and b2 being equal, but results in length a1 being different to length b1. The difference in the lengths a1 and b1 enables the printer controller 208 to determine the degree of cross print bar misalignment. For example, if the length a1 determined from the data signal 804c is longer than the length of a1 determined from the data signal 804a, this indicates that the die is offset in the media advance direction.

As illustrated in FIG. 8d, the die 404d that printed the sub-pattern 704d is misaligned in the print bar axis. Accordingly, the obtained data signal 804d has the same shape as the reference data signal 806a, but is offset therefrom. The amount of offset enables the printer controller 208 to determine the degree and direction of print bar misalignment.

As illustrated in FIG. 8e, the die 404e that printed the sub-pattern 704e is misaligned in both the print bar axis and in the cross print bar axis. Accordingly, the lengths a1, b1, b2, and a2 determined from the obtained data signal 804e enable the printer controller 208 to determine the degree of cross print bar misalignment, and the amount of offset of the data signal 804e compared to the reference data signal 806e enables the printer controller 208 to determine the degree and direction of print bar axis misalignment.

As illustrated in FIG. 8f, the die 404f that printed the sub-pattern 704f has both rotational misalignment and is misaligned in the print bar axis. Using the techniques described above, the printer controller 208 can determine the angle of rotational misalignment and the degree and direction of print bar axis misalignment.

As illustrated in FIG. 8g, the die 404g that printed the sub-pattern 704g has both rotational misalignment and is misaligned in the cross print bar axis. Using the techniques described above, the printer controller 208 can determine the angle of rotational misalignment and the degree and direction of cross print bar axis misalignment.

As illustrated in FIG. 8h, the die 404h that printed the sub-pattern 704h has rotational misalignment and is misaligned in both the print bar axis and in the cross print bar axis. Using the techniques described above, the printer controller 208 can determine the angle of rotational misalignment, the degree and direction of print bar axis misalignment and the degree and direction of cross print bar axis misalignment.

Once the printer controller 208 has determined the presence and degree and direction of any die misalignment, it may, as illustrated in FIG. 9, further determine alignment compensation data to correct, or mitigate, for any such misalignment. For example, correction may include adjusting nozzle firing timing, logical shifting of nozzles used in each die, or any other appropriate technique.

In one example, the printer controller 208 may determine an average die misalignment per printhead, for example, based on determined die misalignments for one or multiple ones of the dies in each printhead.

The examples above have been illustrated using a pattern 702 comprising sub-patterns 704, with each sub-pattern comprising three spaced vertical lines, with one oblique line joining one end of the first and second vertical lines, and a second oblique line joining one end of the second and third lines, in a generally ‘M’ shaped arrangement. The combination of vertical lines and oblique lines enables the printer controller 208 to determine a degree of misalignment of the aforementioned types in a quick and efficient manner. In the examples described above, only a single pattern 702 has to be printed and a single scan of a portion of the printed pattern is sufficient to enable alignment characteristics of a printhead die to be determined. The vertical lines provide accurate reference points to enable print bar misalignment to be determined, and the oblique lines provide accurate reference points to enable rotational misalignment and cross print bar misalignment to be determined. Furthermore, the pattern 702 may be printed at a relatively small height, for example less than 5 cm, which reduces the amount of media wasted during a die alignment procedure.

FIG. 10 shows a number of non-limiting examples 1002, 1004, 1006, 1008, 1010 and 1012, of other sub-patterns that have features that are suitable for enabling various types of die misalignment, as described herein, to be determined. It can be seen that each of these patterns comprises at least one vertical line and at least one oblique line.

It will be appreciated that examples described herein can be realized in the form of hardware, or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are example of machine-readable storage that are suitable for storing a program or programs that, when executed, implement examples described herein. Accordingly, examples provide a program comprising code for implementing a system or method as claimed in any preceding claim and a machine readable storage storing such a program.

1. A system for determining an alignment characteristic of a print member, comprising:
an imaging member; and
a controller to:
control a print member comprising at least one printhead die comprising a plurality of nozzles, to print using at least some of the nozzles of the at least one printhead die a predetermined test pattern;
control the imaging member to obtain data representing at least a portion of the printed predetermined test pattern; and
analyze the obtained data to determine an alignment characteristic of the at least one printhead die.

2. The system of claim 1, wherein the controller is to analyze the obtained data to determine an alignment characteristic of the at least one printhead die in one or more of: an x-axis parallel to the axis of the print member; a y-axis perpendicular to the axis of the print member; and a degree of rotation relative to a plane defined by the x and y axes.

3. The system of claim 1, wherein:
the print member comprises a plurality of printhead dies;
the predetermined test pattern comprises a set of sub-patterns; and
the controller is to control each printhead die to print a different one of the set of sub-patterns.

4. The system of claim 1, wherein the controller is control the imaging member to obtain data representing a portion of the printed test pattern in a single scan.

5. The system of claim 2, wherein the controller is to control the imaging member to print a pattern having features suitable to enable the controller to determine the alignment characteristic.

6. The system of claim 5, wherein the pattern comprises at least one vertical line and at east one oblique line.

7. The system of claim 2, wherein the controller is to determine the alignment characteristic based on determined distances between different portions of the obtained data.

8. The system of claim 7, wherein the controller is to determine the alignment characteristic by comparing determined distances from a scanned portion of the pattern printed and reference data.

9. The system of claim 1, wherein the controller is to determine alignment compensation data based on the determined alignment characteristic.

10. A method of determining an alignment characteristic of a printhead die installed in a printer, comprising:
controlling the printer to print a predetermined pattern using the printhead die; and
determining, through analysis of the distance between features of the printed predetermined pattern, an alignment characteristic of the printhead die.

11. The method of claim 10, further comprising obtaining data representing a portion of the pattern from a predetermined portion of the printed predetermined pattern.

12. The method of claim 10, wherein printing a predetermined pattern comprises printing a pattern having at least one vertical line and at least one oblique line.

13. The method of claim 10, further comprising determining alignment compensation data based on the determined alignment characteristics.

14. The method of claim 13, further comprising applying the determined alignment compensation data to the printer to correct for any determined printhead die misalignment.

15. A printer comprising a controller to control the printer to:
print, on a media, a predetermined pattern using a single printhead die;
obtain data from the media relating to a portion of the printed predetermined pattern;
determine, from the obtained data, an alignment characteristic of the single printhead die; and
compensate for any printhead die misalignment based on the determined alignment characteristic.
